(19) United States
(12) Patent Application Publication
(10) Pub. No.: US 2008/0114675 A1
(43) Pub. Date: May 15, 2008

(54) Parking Payment System Using a Cell Phone or Other Mobile Device

(75) Inventor: Seth Ward, Little Rock, AR (US)

Correspondence Address: CONLEY ROSE, P.C., 5601 GRANITE PARKWAY, SUITE 750, PLANO, TX, 75024, US

(73) Assignee: POM Incorporated, Russellville, AR (US)

(21) Appl. No.: 11/619,640

(22) Filed: Jan. 4, 2007

Related U.S. Application Data
(60) Provisional application No. 60/865,370, filed on Nov. 10, 2006.

(51) Int. Cl. G06Q 30/00; G06Q 20/00; G01C 21/00; G07C 1/30; G06Q 99/00

(52) U.S. Cl. 705/39; 40/333; 701/300; 705/1

(57) ABSTRACT

A parking payment system is provided that includes a telecommunication provider and a mobile device. The mobile device is supported by the telecommunication provider. The mobile device promotes a customer identifying a parking space and further promotes the customer selecting to pay for the parking space. The telecommunication provider bills the customer for fees associated with the parking space in response to the customer selecting to pay for the parking space. The system also includes an enforcement device that displays a graphical user interface (GUI) that identifies a plurality of the parking spaces and indicia associated with each of the plurality of parking spaces. The indicia indicates whether a parking fee has been paid for the associated parking space.

### CROSS-REFERENCE TO RELATED APPLICATIONS

This application claims priority to U.S. Provisional Patent Application No. 60/865,370, entitled “Cell Phone Parking Payment System”, filed on Nov. 10, 2006, by Seth Ward II, which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

When parking in a parking space associated with a typical parking meter, a customer might deposit coins into the meter to pay a fee for the use of the parking space. In an advance over the traditional parking meter, a customer might be able to prepay a certain amount of parking expenses. In an example of this case, the customer might have a card or similar device in or on which a magnetic strip, a radio frequency identification transmitter, or a similar information retention mechanism is embedded. The information retention mechanism on the card might maintain a record of the balance of the customer's prepay parking account. When the customer places the card on or near an appropriately equipped parking meter, a parking fee can added to the meter and a corresponding amount can be deducted from the customer's account.

Alternatively, instead of a parking meter, some other type of identifier for the parking space might be present. For example, a freestanding sign with an identification number for the parking space might be located in a position where a traditional parking meter would typically be located, a placard or other identifying sign might be placed on the ground or on a wall near the parking space, or other ways of identifying the parking space well known to one of skill in the art may be used instead of a traditional parking meter. The customer might enter the identifying information for the parking space into a portable electronic device, such as a cell phone, and the device might cause a parking fee to be deducted from the customer's prepay account. Any such meter or identifier for a parking space will be referred to herein as a parking meter but it should be understood that an apparatus that would traditionally be considered a parking meter might not be present at the parking space.

Prepay systems such as these or other prepay parking systems well known to those of skill in the art can provide an advantage over traditional coin-based systems in that the customer does not need to carry or obtain coins. However, such systems can also have several drawbacks. For example, a prepay system can be inconvenient because the customer may need to remember to add funds to the prepay balance periodically. The procedure for adding funds may be burdensome or time-consuming. Also, the customer may need to remember to carry the prepay card or other prepay device. In addition, the customer may not be able to easily determine the balance on the prepay account. In some cases, the account balance may expire if not used within a certain period of time. Also, the income a municipality or other entity receives from parking fees might be reduced by the expenses incurred in maintaining a prepay system. Also, some individual may not be aware of or have access to prepay systems, so the parking meters would still need to be able to accept coins or other forms of payment.

### SUMMARY

In one embodiment, a parking payment system is provided that includes a telecommunication provider and a mobile device. The mobile device is supported by the telecommunication provider. The mobile device promotes a customer identifying a parking space and further promotes the customer selecting to pay for the parking space. The telecommunication provider bills the customer for fees associated with the parking space in response to the customer selecting to pay for the parking space. The system also includes an enforcement device that displays a graphical user interface (GUI) that identifies a plurality of the parking spaces and indicia associated with each of the plurality of parking spaces. The indicia indicates whether a parking fee has been paid for the associated parking space.

In another embodiment, a method for parking is provided that includes a user using a mobile device to identify a parking space. The method includes receiving, via the mobile device, information regarding parking in the parking space. The method includes selecting to pay a fee to park in the parking space, and charging the fee to a mobile device account associated with the user's mobile device.

In another embodiment, a device for wireless telecommunications is provided. The device includes a display, a processor, and a graphical user interface (GUI). The GUI has a parking aspect displayable on the display such that responsive to a user of the device selecting the parking aspect, the processor is programmed to identify a parking space. The processor is further programmed to receive information regarding parking in the parking space. Responsive to the user selecting to pay a fee to park in the parking space, the processor is programmed to promote charging the fee to a device account associated with the user's device.

These and other features and advantages will be more clearly understood from the following detailed description taken in conjunction with the accompanying drawings and claims.

### BRIEF DESCRIPTION OF THE DRAWINGS

For a more complete understanding of the disclosure and the advantages thereof, reference is now made to the following brief description, taken in connection with the accompanying drawings and detailed description, wherein like reference numerals represent like parts.

FIG. 1 illustrates a parking fee payment system according to an embodiment of the disclosure.

FIGS. 2a-2d illustrate parking fee payment interfaces according to an embodiment of the disclosure.

FIGS. 3a and 3b illustrates a parking fee payment enforcement system according to an embodiment of the disclosure.

FIG. 4 illustrates a method for paying a parking fee according to an embodiment of the disclosure.

FIG. 5 is a diagram of a wireless communications system including a mobile device operable for some of the various embodiments of the disclosure.

FIG. 6 is a block diagram of a mobile device operable for some of the various embodiments of the disclosure.

FIG. 7 is a diagram of a software environment that may be implemented on a mobile device operable for some of the various embodiments of the disclosure.

### DETAILED DESCRIPTION

It should be understood at the outset that although an illustrative implementation of one embodiment of the disclosure is illustrated below, the system may be implemented using any number of techniques, whether currently known or in existence. The disclosure should in no way be limited to the illustrative implementations, drawings, and techniques illustrated below, including the exemplary design and implementation illustrated and described herein, but may be modified within the scope of the appended claims along with their full scope of equivalents.

In an embodiment, a system is provided whereby a mobile telecommunications-capable device can be used to credit a parking meter with a parking fee. Any easily portable device that is capable of connecting to a wireless telecommunications network, such as a cell or other mobile phone, a personal digital assistant, a portable computer, or a similar device, will be referred to herein as a mobile device. When a customer parks a vehicle in a parking space associated with a parking meter equipped as described herein, the customer can use a mobile device to transmit an identifier for the parking meter to the telecommunications provider that provides wireless service to the mobile device. The telecommunications provider can then communicate with an entity that manages the parking meter and cause the parking meter to be electronically credited with the appropriate fee for parking in the parking space.

The meter management entity might then communicate with the parking meter and/or with the mobile device to cause an indication that the fee has been credited to appear on the parking meter and/or on the mobile device. The meter management entity might also update its records to indicate that the fee has been credited so that those records can be used to enforce the payment of parking fees. The telecommunications provider can place the parking fees on the customer's bill. In this way, the need for a customer to prepay parking fees is eliminated and the disadvantages previously mentioned for prepay systems can be avoided.

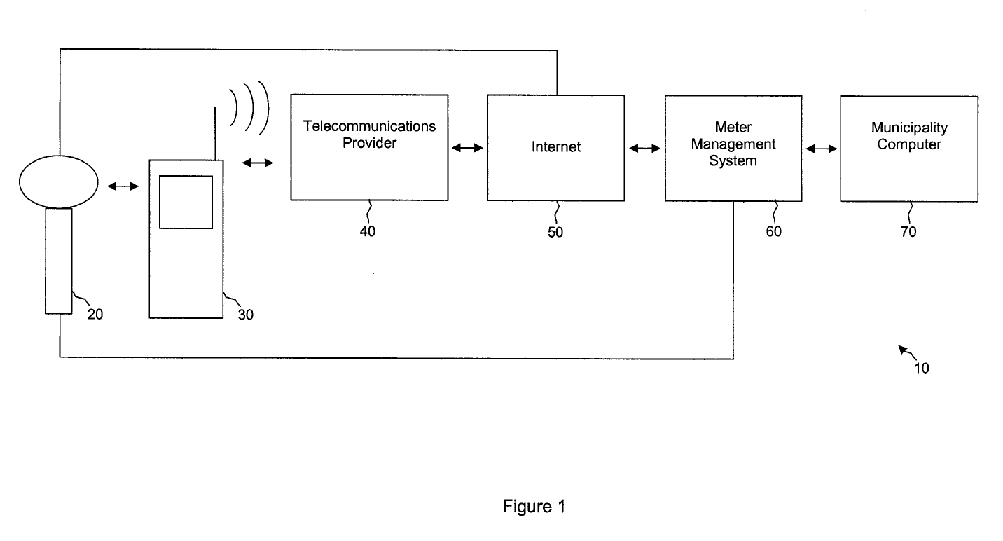

FIG. 1 illustrates an embodiment of a system 10 that can allow the payment of parking fees via a mobile device 30. When a telecommunications service customer parks a vehicle in a parking space associated with a parking meter 20, identifying information for the parking meter 20 can be entered into the customer's mobile device 30 or otherwise recorded. As mentioned previously, the parking meter 20 might be a traditional parking meter that displays identifying information or that has been given additional functionality related to the current payment system, might be a sign or other apparatus containing identifying information associated with the parking space, or might be some other type of pay station that associates identifying information with a parking space.

The association of the parking meter 20 with the mobile device 30 can be accomplished in several different manners. In one embodiment, the parking meter 20 might display a serial number or similar identifying text. The customer could enter this identifier into the mobile device 30 by manually keying the number into the keypad on the mobile device 30, by speaking the number into a voice recognition system in the mobile device 30, or by other well known data entry techniques.

In another embodiment, the mobile device 30 might be equipped with a global positioning system (GPS) or similar system for determining the location of the mobile device 30. The mobile device 30 might transmit information regarding its location to a telecommunications provider 40 and the telecommunications provider 40 might transmit this information to a parking meter management system 60, described in detail below. The meter management system 60 might be able to use this information to determine the nearest parking meter 20 to the location of the mobile device 30 and to automatically enter an identifier for that parking meter 20 into the mobile device 30. Alternatively, the identifier or other information to associate the mobile device 30 with that particular parking space might simply be recorded by the meter management system 60.

In another embodiment, the parking meter 20 might be equipped with a radio frequency identification (RFID) transmitter or a similar proximity-based identity transmission system. The mobile device 30 might be equipped with an RFID receiver or some other receiver appropriate for the type of transmitter on the parking meter 20. The customer might bring the mobile device 30 into the proximity of the parking meter 20 and the identity transmission system on the parking meter 20 might cause an identifier for the parking meter 20 to be transmitted to the mobile device 30. In a variation of this embodiment, the mobile device 30 might be equipped with the transmitter and the parking meter 20 might be equipped with the receiver. Bringing the mobile device 30 into the proximity of the parking meter 20 might cause identifying information for the mobile device 30 to be sent to the parking meter 20.

In yet another embodiment, the parking meter 20 and the mobile device 30 might be equipped with a Bluetooth data transmission system or similar wireless data transmission system. When the customer brings the mobile device 30 into the proximity of the parking meter 20, the wireless data transmission system might cause an identifier for the parking meter 20 to be transmitted to the mobile device 30 or an identifier for the mobile device 30 to be transmitted to the parking meter 20. One of skill in the art will recognize other ways in which an identifier for the parking meter 20 could be associated with the mobile device 30.

In the cases where the identifier for the parking meter 20 is entered into the mobile device 30, the identifier can be transmitted by the mobile device 30 to the telecommunications provider 40 that provides service to the mobile device 30 or to the meter management system 60. While only one telecommunications provider 40 is shown in FIG. 1, it should be understood that a plurality of telecommunications providers 40 might be present. That is, several telecommunications providers 40 might provide wireless service in a particular geographical area and different mobile devices 30 might use the services of different telecommunications providers 40. A customer of any of the plurality of telecommunications providers 40 might be able to make use of the parking payment system described herein.

In the cases where identifying information for the mobile device 30 is transmitted to the parking meter 20, the parking meter 20 might transmit its identifier and the identifying information for the mobile device 30 to the telecommunications provider 40, to the parking meter management system 60, or to the Internet 50, or other intermediate networks, and thence to the parking meter management system 60.

In one embodiment, the customer might enter the identifier for the parking meter 20 into the mobile device 30 before calling the telecommunications provider 40. In this case, the mobile device 30 might have a menu item that, when selected, causes an interface to appear on the mobile device 30 into which the identifier can be entered. Upon entry of the identifier and other parking-related information into the interface, a telephone call could be placed to the telecommunications provider 40 to send the identifier and the other parking-related information to the telecommunications provider 40. The customer might manually place the telephone call or the mobile device 30 might automatically place the telephone call upon the customer entering the identifier and the other parking-related information.

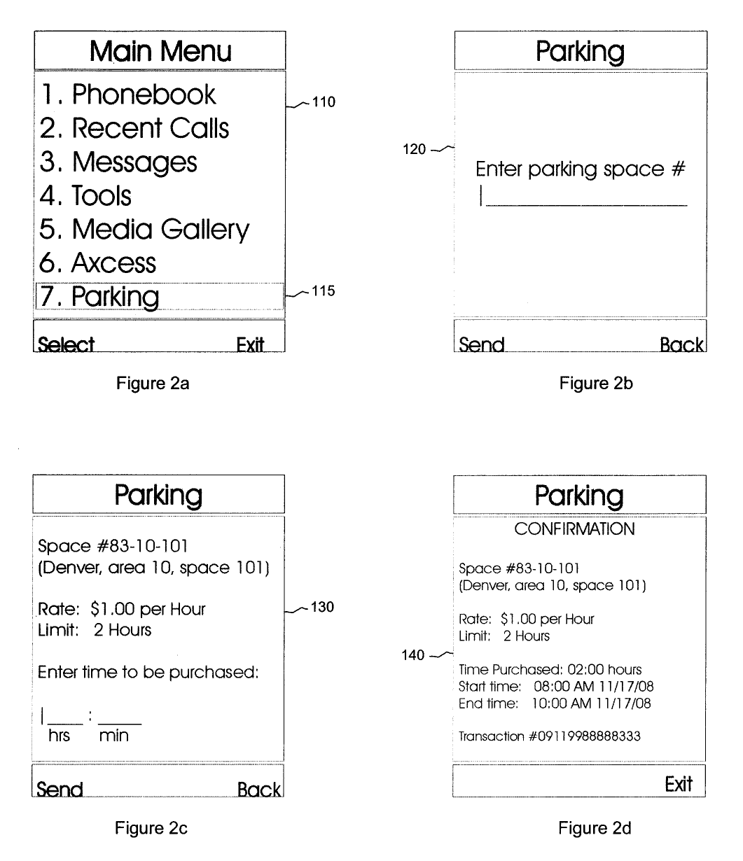

FIGS. 2a-2d illustrate interfaces that might appear on the display screen of the mobile device 30 in an example of this embodiment. In FIG. 2a, a main menu interface 110 lists a plurality of menu items, one of which is a parking menu item 115. When the parking menu item 115 is selected, a second interface 120 shown in FIG. 2b might appear, into which the identifier for a selected parking space can be entered. When the identifier has been entered, a third interface 130 shown in FIG. 2c might appear, wherein information about the parking space might be displayed and into which a desired period of parking time can be entered. When the desired parking time has been entered, a call could be placed to the telecommunications provider 40 or the mobile device 30 might otherwise communicate the information that has been entered to the telecommunications provider 40. In response a fourth interface 140, shown in FIG. 2d, may appear, wherein a confirmation of the purchase of parking time for the selected parking space is displayed. The confirmation might include a transaction number for the parking event that might be used for recording purposes by the meter management system 60 and for confirmation purposes by the customer.

In another embodiment, the customer might call the telecommunications provider 40 before entering the identifier for the parking meter 20 into the mobile device 30. In this case, the telecommunications provider 40, upon receiving the call, might cause one or more interfaces to appear on the mobile device 30 into which the identifier and other parking-related information can be entered. Each time the customer enters parking-related information into the interfaces, the information could be sent to the telecommunications provider 40 and the telecommunications provider 40 might then send another interface into which further information could be entered.

FIGS. 2b-2d might again be used to illustrate this embodiment. When the mobile device 30 calls a parking-related telephone number, the telecommunications provider 40 might transmit or otherwise cause the interface 120 of FIG. 2b to be displayed on the mobile device 30. The customer might then enter a parking space identifier as described above and send the identifier to the telecommunications provider 40. The telecommunications provider 40 might then transmit the interface 130 of FIG. 2c to the mobile device 30 and the customer might enter a period of parking time as described above and send the time to the telecommunications provider 40. The telecommunications provider 40 might then send a confirmation as described above and as depicted in FIG. 2d.

In either of these cases, the identifying information for the parking meter 20 and the other parking-related information might be transmitted from the mobile device 30 to the telecommunications provider 40 or the meter management system 60 in the form of a Short Message Service (SMS) text message or in a similar data transmission protocol.

Upon receiving a telephone call with the identifier for the parking meter 20, the telecommunications provider 40 can cause a credit for the fee for parking at the parking meter 20 to be recorded at the parking meter 20 and/or at the meter management system 60. Various arrangements for the transfer of funds for the parking fee will be discussed in detail below. In an embodiment, communication between the telecommunications provider 40 and the meter management system 60 occurs via the Internet 50, but other connections could be used.

In one embodiment, the customer can use the mobile device 30 to specify the amount of the fee that should be credited to the parking meter 20. For example, as shown in FIG. 2c, the customer might enter a desired length of parking time into the keypad of the mobile device 30. The mobile device 30 might then send that desired length of time to the telecommunications provider 40. A fee appropriate for that length of time might then be electronically credited to the parking meter 20 and/or the meter management system 60 and displayed on the mobile device 30.

In another embodiment, a timer in the parking meter 20 or in the meter management system 60 might start counting at the time the telephone call with the identifier for the parking meter 20 is placed. When the customer moves the vehicle from the parking space, the customer might place a telephone call to the telecommunications provider 40 to inform the telecommunications provider 40 that the parking space is being vacated and the timer might stop counting. A fee based on the length of time the vehicle was in the parking space might be calculated and billed at that point.

When the customer uses the mobile device 30 to pay for parking, the meter management system 60 might cause an indication to appear on the parking meter 20 to provide the customer and parking fee enforcement officials with confirmation that payment has been made. For example, if the customer uses the keypad on the mobile device 30 to specify that one dollar should be credited to the parking meter 20, an amount of one dollar might appear on a display on the parking meter 20. Alternatively an amount of time might be purchased and the time, instead of the dollar amount, might appear on the display of the parking meter 20. The amount shown on the display might decrease with the passage of time in the manner of the displays on some traditional parking meters. In the case where the parking fee is calculated after the parking space is vacated, the parking meter 20 might display some other type of indication that the vehicle is legally parked.

In some embodiments, the customer may prepay for time and receive a credit if the customer vacates the parking space early and notifies the provider or system, such as via the mobile device 30. Further the system may notify the user, via the mobile device 30, when the meter expires or is about to expire and allow the user to pay for additional parking time.

In an embodiment, when the customer uses the mobile device 30 to pay for parking, the meter management system 60 might update its records to indicate that a fee for the parking space has been paid. These records might be used by the telecommunications provider 40 to determine the amount for parking fees that should be added to the customer's telecommunications service bill. The telecommunications provider 40 might update the customer's account each time a fee is incurred or might periodically consult the records of the meter management system 60 to add the fees to the bill on a batch basis. These records might be also used, in a manner described in detail below, in parking fee enforcement efforts.

One of skill in the art will recognize that the above steps do not necessarily need to occur in the order stated. For example, the updating of the display on the parking meter 20, the updating of the records in the meter management system 60, and the addition of a parking fee to a customer's bill could take place substantially simultaneously or in various sequences.

The meter management system 60 might include or be managed by a group, such as a partnership, joint venture, or other business association, of one or more telecommunications providers 40. It is well known that, in the United States and many other countries, a plurality of telecommunications providers 40 might provide service to a particular geographic region. A customer might select any one of the telecommunications providers 40 to provide service for the customer's mobile device 30. If the meter management system 60 included or was managed or associated with only one of the telecommunications providers 40 in a region, only the customers of that telecommunications provider 40 might be able to make use of the parking fee payment system described herein. The adoption of this system might be less desirable to a municipality in such a situation since the number of users to whom the system would be available would be limited. If, however, a group of several telecommunications providers 40, such as a majority of telecommunications providers, were formed for the purpose of administering parking fees and allowed parking fees to be billed to the accounts of the mobile device 30 users, as described herein, customers of any telecommunications provider 40 in the group could use this system. Increasing the number of users to whom the system would be available in this manner could make the adoption of this system more desirable to a municipality.

The meter management system 60 might include one or more computers that are capable of connecting to the Internet 50 and, through the Internet 50, to the parking meter 20. The computers might also be capable of connecting to the parking meter 20 through the telecommunications provider 40, through a direct connection, or through some other type of connection. The meter management system 60 might also include a database or a similar data storage system in which parking records obtained from the parking meter 20 and from the mobile device 30 can be stored and from which the records can be retrieved. Appropriate software for managing the parking meter 20, the database, and the fees related to the parking meter 20 might also be present in the meter management system 60.

In an embodiment, the meter management system 60 can be accessed or used by another entity for parking enforcement purposes. For example, the meter management system 60 might manage the parking spaces, lots, and so on for numerous entities. These other entities would typically be a city, a county, or some other municipality that receives the fees from the parking meter 20. The other entity might also be an airport; an academic institution; an operations or management entity that controls a large parking lot or garage such as the parking lot or garage for a stadium, an arena, or a theater; or a similar entity. The term ‘municipality’ will be used herein to refer to any entity that can access the records of or employ all or portions of the meter management system 60 and use the records and systems to enforce and collect the payment of parking fees.

The municipality might have a computer 70 that can access the records of the meter management system 60. The municipality computer 70 might have the capability to use the records to display a graphical depiction of the parking meters 20 for which a fee has currently been paid and the parking meters 20 for which a fee has not currently been paid. The display might include a map of the streets, garages, or other locations at which the parking meters 20 are present. A user of the municipality computer 70 might be able to zoom in on the streets in the map and view an indicator associated with each parking meter 20 in the municipality. The indicators might show whether or not each parking meter 20 is currently credited with a parking fee. This information could then be used for parking fee enforcement purposes.

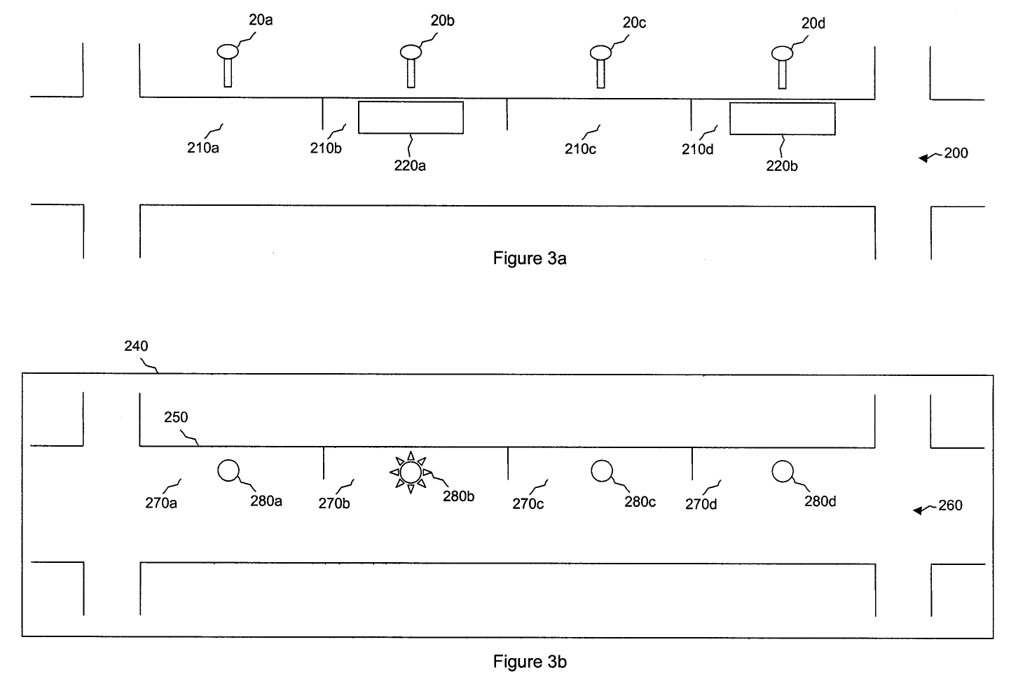

FIGS. 3a and 3b illustrate such a scenario. In FIG. 3a, a plurality of parking meters 20 are present on a street 200. Each parking meter 20 is associated with a parking space 210. That is, a first parking meter 20a is associated with a first parking space 210a, a second parking meter 20b is associated with a second parking space 210b, and so on. In this example, a first vehicle 220a is parked in the second parking space 210b and a second vehicle 220b is parked in the fourth parking space 210d. It will be assumed for this example that a fee has currently been paid for the second parking meter 20b but that a fee has not currently been paid for the fourth parking meter 20d. That is, the second vehicle 220b is in violation of the parking regulations for the municipality in which the street 200 is located.

FIG. 3b illustrates a display screen 240 that might appear on the municipality computer 70. The screen 240 includes a map 250 that depicts the street 200 and the parking spaces 210 illustrated in FIG. 3a. That is, a virtual street 260 corresponds to the actual street 200 and a plurality of virtual parking spaces 270 correspond to the actual parking spaces 210. An indicator 280 is associated with each of the virtual parking spaces 270 to provide a graphical depiction of whether a fee has currently been paid for the parking meter 20 associated with the actual parking space 210 depicted by the virtual parking space 270. That is, when a fee is paid for one of the parking meters 20, the corresponding indicator 280 will provide an indication that the fee has been paid. The indicators 280 might be lights that are illuminated when a fee has been paid and that are not illuminated when a fee has not been paid, lights that are a first color when a fee has been paid and a second color when a fee has not been paid, pairs of lights, one of which is a first color when a fee has been paid and the other of which is a second color when a fee has not been paid, or other types of indicators well known to those of skill in the art.

A user of the municipality computer 70, such as an enforcement officer using a laptop computer or other handheld or portable device, can observe the indicators 280 on the screen 240 and determine which parking meters 20 on the street 200 are currently credited with a parking fee. In this example, it can be seen that indicator 280b is illuminated and the other indicators 280 are not illuminated. This indicates that a fee has currently been paid for the second parking space 210b but that a fee has not currently been paid for the other parking spaces 210a, 210c, and 210d.

An observation can then be made of the actual parking spaces 210. It will be seen that the second parking space 210b and the fourth parking space 210d are occupied and that the first parking space 210a and the third parking space 210c are unoccupied. When a comparison is made between the parking spaces 210 for which a fee has been paid and the parking spaces 210 that are occupied, it will be observed that the second vehicle 220b is occupying the fourth parking space 210d without having paid a sufficient fee.

In one embodiment, the municipality computer 70 is a personal digital assistant, a portable computer, or a similar device that can be carried by a parking enforcement officer. The officer might walk alongside the street 200 with the municipality computer 70 and compare occupied parking spaces 210 with the indicators 280 on the municipality computer 70. Alternatively, the officer might ride in a vehicle along the street 200 and compare occupied parking spaces 210 with the indicators 280 on the municipality computer 70. In these cases, the municipality computer 70 might be equipped with a printer that allows a citation to be printed on the spot when a violation is observed. In one embodiment, the municipality computer 70 might be equipped with a positioning system, such as a geographical positioning system (GPS), so that the enforcement officer or the enforcement officer's vehicle carrying the municipality computer 70 may be identifiable on the street 200 or elsewhere. This might be useful to allow the enforcement office to more readily determine the location of nearby parking spaces and thereby simplify enforcement.

In another embodiment, the municipality computer 70 might remain in a fixed location and cameras might be used to monitor the parking spaces 210. A first parking enforcement officer at the fixed location could make a comparison between the indicators 280 and presence of vehicles in the parking spaces 210 as observed on a monitor. When such a comparison reveals a parking violation, the first parking enforcement officer could dispatch a second parking enforcement officer to the location of the violation.

In yet another embodiment, the municipality computer 70 could be coupled to a system that automatically detects the presence of vehicles in the parking spaces 210, perhaps through the use of sonar or other well known vehicle detection techniques. When the municipality computer 70 and the vehicle detection system together detect the presence of a vehicle in a parking space 210 for which a fee has not been paid, enforcement actions could be initiated against the vehicle. One of skill in the art will recognize other ways in which the indicators 280 on the display screen 240 of the municipality computer 70 could assist in enforcing the payment of parking fees.

As mentioned previously, the transfer of funds for a parking fee between the customer, the telecommunications provider 40, the meter management system 60, and the municipality can be carried out in several different ways. In one embodiment, when the telecommunications provider 40 receives the customer's payment for a bill in which parking fees are included, the telecommunications provider 40 might keep a percentage of the parking fee portion of the payment as a service fee. The telecommunications provider 40 might then send the remaining parking fee portion of the payment to the entity that manages the meter management system 60. The entity that manages the meter management system 60 might keep a percentage of this remaining portion as a service fee and send the remainder of the parking fee portion of the payment to the municipality.

In another embodiment, at or shortly after the time the customer uses the mobile device 30 to credit a parking fee to the parking meter 20, the telecommunications provider 40 might send the amount of the parking fee to the municipality. The telecommunications provider 40 might later send the customer a bill that includes a service fee in addition to the parking fee sent to the municipality. When the customer pays the bill, the telecommunications provider 40 might keep a portion of the service fee and send the remainder of the service fee to the entity that manages the meter management system 60.

In yet another embodiment, at or shortly after the time the customer uses the mobile device 30 to credit a parking fee to the parking meter 20, the telecommunications provider 40 might send the amount of the parking fee and a first service fee to the entity that manages the meter management system 60. The entity that manages the meter management system 60 might then send the amount of the parking fee to the municipality and keep the first service fee for itself. The telecommunications provider 40 might later send the customer a bill that includes a second service fee in addition to the parking fee and the first service fee. When the customer pays the bill, the telecommunications provider 40 might keep the first and second service fees and the parking fee for itself.

In still other embodiments, the entity that manages the meter management system 60 might initiate and manage the fee payment process and might be reimbursed by the telecommunications provider 40 when the telecommunications provider 40 receives payment from the customer. One of skill in the art will recognize other arrangements that could be made for the payment of parking fees to the municipality and the payment of service fees to the telecommunications provider 40 and to the entity that manages the meter management system 60.

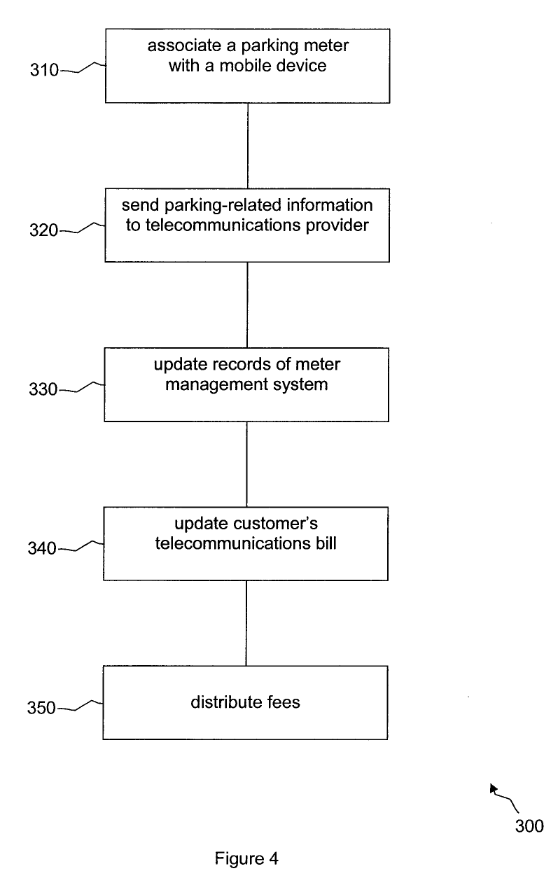

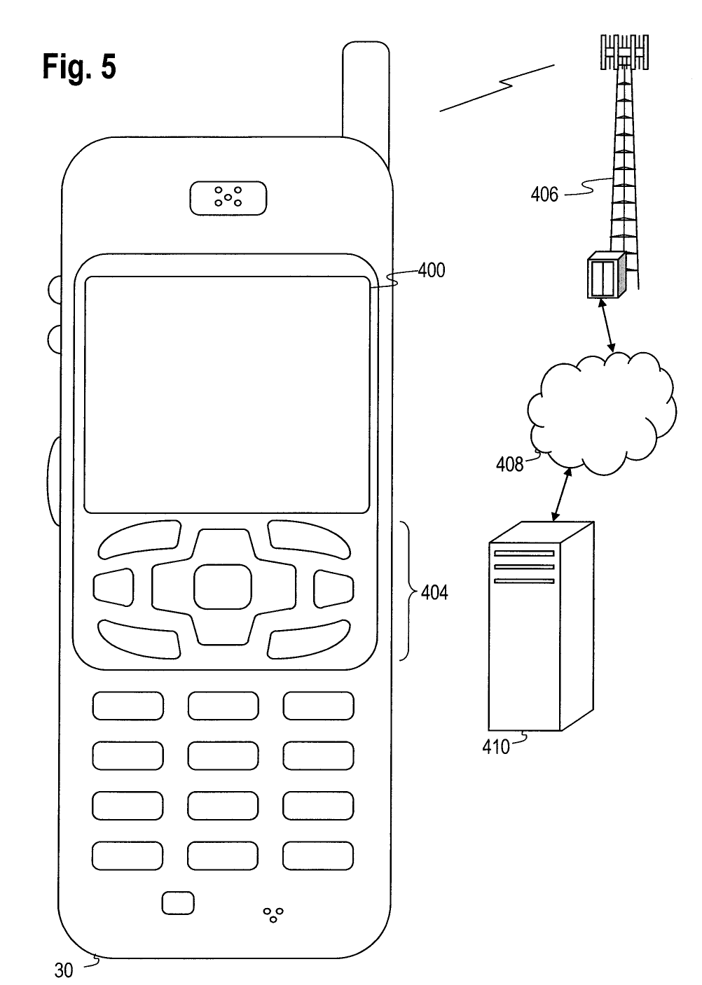

FIG. 4 illustrates a method 300 for using a mobile device to pay a parking fee. In block 310, a parking meter is associated with a mobile device. The association might be made by the mobile device user entering an identification number for the parking meter into the mobile device or through other techniques. In block 320, parking-related information is sent to a telecommunications provider. The telecommunications provider might then send the information to a parking meter management system. In other embodiments, the parking-related information might be sent directly to the parking meter management system. In block 330, the records of the meter management system are updated to indicate that a parking fee has been credited to the parking meter. The records might be used to assist in the enforcement of parking fees. The parking meter might also be updated to indicate that the parking fee has been credited. In block 340, the telecommunications provider updates the customer's bill with the parking fee. In block 350, the parking fee and any service fees charged by the telecommunications provider and by the meter management system are distributed among the telecommunications provider, the meter management system, and the municipality that controls the parking meter.

In some embodiments, the meter management system might be owned and operated by a joint venture of the telecommunications companies. In other embodiments, the meter management system might be independently owned and operated. In either case, the telecommunications providers might receive some benefit, such as fee or charge for each parking event, or for enabling user access to the parking system, or other financial benefit. When the user pays their bill for services for the mobile device, which includes the parking fees, the telecommunications providers might then disperse all or portions of the collected fees to the meter management system entity and municipality or other parking space entity.

It should be understood that the above steps do not necessarily need to occur in the stated sequence. For example, the updating of the meter management system's records, the updating of the bill, and the distribution of fees could occur in other orders. One of skill in the art will recognize other sequences in which the steps in the method 300 could occur.

A parking payment system as described herein can provide enhancements to customers, telecommunications providers, and municipalities. For the customer, a service might be provided whereby the customer is allowed access to a portion of the records of the meter management system. The customer might then be able to use a mobile device to search the records to find a convenient parking space. For example, if the mobile device is equipped with a GPS system, the customer's GPS-based location information could be combined with the records of the meter management system. This combined information could then be used to create a map that could be displayed on the screen of the mobile device and could show the presence of vacant parking spaces near the customer's current location.

The records of the meter management system could also be used to automatically send an alert to the customer's mobile device when the purchased time on a parking meter is about to expire. The alert might offer the customer the opportunity to extend the time on the parking meter. Upon receiving the alert, the customer might choose to vacate the parking space before the time expires, might return to the parking space to add money to the parking meter either manually or via the mobile device, or might use the mobile device to remotely credit the parking meter with additional funds.

Other services that may be available to the customer when a system such as that described herein is in place include access to premium parking spaces that would not be available to non-users of this system and the opportunity to pay parking citations via the mobile device. One of skill in the art might recognize other services that might be made available to customers who make use of this system.

Also, the use of a mobile device as described herein to pay parking fees can eliminate many of the drawbacks to the customer of a prepay parking plan. The customer does not need to remember to periodically add funds to the prepay balance. The burden and time required for adding funds are eliminated. The customer does not need to remember to carry a prepay card or other prepay device since payment is made via a mobile device that the customer might already be carrying for other purposes. The customer does not need to determine the remaining balance on a prepay account and there is no prepay account balance that could expire.

Telecommunications providers that offer services such as these to their customers might be able to enhance their revenues through the collection of service fees for managing the payment of parking fees. Municipalities that adopt a parking payment system such as this can reduce the expenses incurred in maintaining prepay systems and/or traditional parking fee payment systems. For example, it is well known in the art that a high percentage of the revenue generated through parking fees is lost through theft and vandalism. It is also well known that a large portion of the revenue collected from parking fees is spent on maintenance of equipment and manual collection of money from parking meters. The use of a parking payment system as described herein can reduce all of these losses and expenses and thus increase the net revenue a municipality receives from parking fees. In addition, a municipality might enter into a contract with the entity that manages the meter management system to perform some of the parking fee-related functions that were previously performed by the municipality. This might further reduce the direct expenses that are incurred by the municipality.

While the present system may be used in conjunction with coin operated parking meters, coin operated meters are not necessary for the present system. In fact, a municipality employing the present system may entirely eliminate their coin operated meters. Coin operated meters have a number of drawbacks including the cost of collecting the coins, vandalism, and the actual cost of the coin operated meters. By employing the present system and eliminating coin operated meters, the municipality would enjoy considerable savings.

FIG. 5 shows a wireless communications system including the mobile device 30. The mobile device 30 is operable for implementing aspects of the disclosure, but the disclosure should not be limited to these implementations. Though illustrated as a mobile phone, the mobile device 30 may take various forms including a wireless handset, a pager, a personal digital assistant (PDA), a portable computer, a tablet computer, or a laptop computer. Many suitable mobile devices combine some or all of these functions. In some embodiments of the disclosure, the mobile device 30 is not a general purpose computing device like a portable, laptop or tablet computer, but rather is a special-purpose communications device such as a mobile phone, wireless handset, pager, or PDA.

The mobile device 30 includes a display 400 that might include the screen 240. The mobile device 30 also includes a touch-sensitive surface or keys 404 for input by a user. The mobile device 30 may present options for the user to select, controls for the user to actuate, and/or cursors or other indicators for the user to direct. The mobile device 30 may further accept data entry from the user, including numbers to dial or various parameter values for configuring the operation of the mobile device 30. The mobile device 30 may further execute one or more software or firmware applications in response to user commands. These applications may configure the mobile device 30 to perform various customized functions in response to user interaction.

Among the various applications executable by the mobile device 30 are a web browser, which enables the display 400 to show a web page. The web page is obtained via wireless communications with a cell tower 406, a wireless network access node, or any other wireless communication network or system. The cell tower 406 (or wireless network access node) is coupled to a wired network 408, such as the Internet. Via the wireless link and the wired network, the mobile device 30 has access to information on various servers, such as a server 410. The server 410 may provide content that may be shown on the display 400.

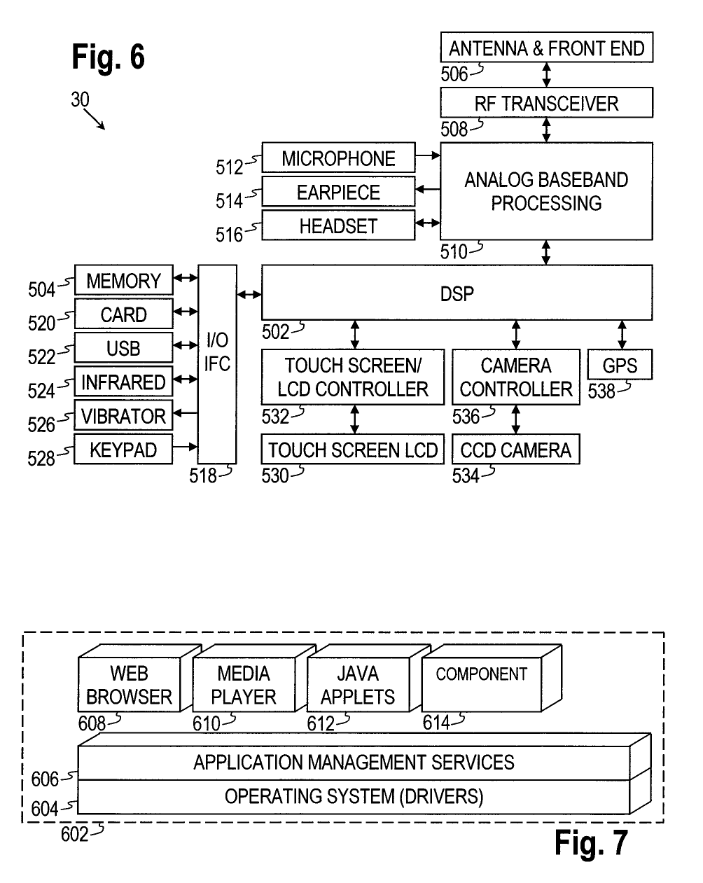

FIG. 6 shows a block diagram of the mobile device 30. The mobile device 30 includes a digital signal processor (DSP) 502 and a memory 504. As shown, the mobile device 30 may further include an antenna and front end unit 506, a radio frequency (RF) transceiver 508, an analog baseband processing unit 510, a microphone 512, an earpiece speaker 514, a headset port 516, an input/output interface 518, a removable memory card 520, a universal serial bus (USB) port 522, an infrared port 524, a vibrator 526, a keypad 528, a touch screen liquid crystal display (LCD) with a touch sensitive surface 530, a touch screen/LCD controller 532, a charge-coupled device (CCD) camera 534, a camera controller 536, and a global positioning system (GPS) sensor 538.

The DSP 502 or some other form of controller or central processing unit operates to control the various components of the mobile device 30 in accordance with embedded software or firmware stored in memory 504. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, or the application software may be high-level software instructions to be processed by an interpreter or compiler to indirectly configure the DSP 502.

The antenna and front end unit 506 may be provided to convert between wireless signals and electrical signals, enabling the mobile device 30 to send and receive information from a cellular network or some other available wireless communications network. The RF transceiver 508 provides frequency shifting, converting received RF signals to baseband and converting baseband transmit signals to RF. The analog baseband processing unit 510 may provide channel equalization and signal demodulation to extract information from received signals, may modulate information to create transmit signals, and may provide analog filtering for audio signals. To that end, the analog baseband processing unit 510 may have ports for connecting to the built-in microphone 512 and the earpiece speaker 514 that enable the mobile device 30 to be used as a cell phone. The analog baseband processing unit 510 may further include a port for connecting to a headset or other hands-free microphone and speaker configuration.

The DSP 502 may send and receive digital communications with a wireless network via the analog baseband processing unit 510. In some embodiments, these digital communications may provide Internet connectivity, enabling a user to gain access to content on the Internet and to send and receive e-mail or text messages. The input/output interface 518 interconnects the DSP 502 and various memories and interfaces. The memory 504 and the removable memory card 520 may provide software and data to configure the operation of the DSP 502. Among the interfaces may be the USB interface 522 and the infrared port 524. The USB interface 522 may enable the mobile device 30 to function as a peripheral device to exchange information with a personal computer or other computer system. The infrared port 524 and other optional ports such as a Bluetooth interface or an IEEE 802.11 compliant wireless interface may enable the mobile device 30 to communicate wirelessly with other nearby mobile devices and/or wireless base stations.

The input/output interface 518 may further connect the DSP 502 to the vibrator 526 that, when triggered, causes the mobile device 30 to vibrate. The vibrator 526 may serve as a mechanism for silently alerting the user to any of various events such as an incoming call, a new text message, and an appointment reminder.

The keypad 528 couples to the DSP 502 via the interface 518 to provide one mechanism for the user to make selections, enter information, and otherwise provide input to the mobile device 30. Another input mechanism may be the touch screen LCD 530, which may also display text and/or graphics to the user. The touch screen LCD controller 532 couples the DSP 502 to the touch screen LCD 530.

The CCD camera 534 enables the mobile device 30 to take digital pictures. The DSP 502 communicates with the CCD camera 534 via the camera controller 536. The GPS sensor 538 is coupled to the DSP 502 to decode global positioning system signals, thereby enabling the mobile device 30 to determine its position. Various other peripherals may also be included to provide additional functions, e.g., radio and television reception.

FIG. 7 illustrates a software environment 602 that may be implemented by the DSP 502. The DSP 502 executes operating system drivers 604 that provide a platform from which the rest of the software operates. The operating system drivers 604 provide drivers for the mobile device hardware with standardized interfaces that are accessible to application software. The operating system drivers 604 include application management services (“AMS”) 606 that transfer control between applications running on the mobile device 30. Also shown in FIG. 7 are a web browser application 608, a media player application 610, and Java applets 612. The web browser application 608 configures the mobile device 30 to operate as a web browser, allowing a user to enter information into forms and select links to retrieve and view web pages. The media player application 610 configures the mobile device 30 to retrieve and play audio or audiovisual media. The Java applets 612 configure the mobile device 30 to provide games, utilities, and other functionality. A component 614 might provide functionality related to the payment of parking fees.

While several embodiments have been provided in the disclosure, it should be understood that the disclosed systems and methods may be embodied in many other specific forms without departing from the spirit or scope of the disclosure. The examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed:

1. A parking payment system, comprising:
a telecommunication provider; and
a mobile device supported by the telecommunication provider, the mobile device promoting a customer identifying a parking space and further promoting the customer selecting to pay for the parking space, wherein the telecommunication provider bills the customer for fees associated with the parking space in response to the customer selecting to pay for the parking space.

2. The parking payment system of claim 1, further comprising:
a parking sign including indicia associated with the parking space, and wherein the user uses the mobile device and the indicia associated with the parking space to promote identifying the space.

3. The parking payment system of claim 2, wherein the parking sign is a parking meter with indicia provided on the parking meter.

4. The parking payment system of claim 1, further comprising:
a parking meter operable to communicate with the mobile device and provide information to the mobile device identifying the parking space.

5. The parking payment system of claim 1, further comprising:
a computer system to promote managing the parking spaces and to promote communication with the mobile device regarding payment of the fee for the parking space.

6. The parking payment system of claim 5, further comprising a graphical user interface (GUI) identifying a plurality of parking spaces, the GUI operable to indicate when a fee for parking spaces has been paid and the GUI operable to indicate when the fee for parking spaces has not been paid.

7. The parking payment system of claim 6, further comprising a parking enforcement component, and wherein GUI is operable to identify a location of the parking enforcement component relative to the location of the plurality of parking spaces.

8. The parking payment system of claim 7, wherein the parking enforcement component is a parking enforcement computer used by parking enforcement personnel.

9. The parking payment system of claim 5, further comprising a graphical user interface (GUI) operable to promote the customer using the mobile device to locate a vacant parking space.

10. The parking payment system of claim 1, further comprising
a second telecommunication provider; and
a second mobile device supported by the second telecommunication provider, the second mobile device promoting a second customer identifying a second parking space adjacent the parking space and further promoting the second customer selecting to pay for the second parking space, wherein the second telecommunication provider bills the second customer for fees associated with the parking space in response to the customer selecting to pay for the parking space.

11. The parking payment system of claim 1, wherein the telecommunication provider bills the customer for the fees associated with the parking spaces such that the fees for the parking space appears on the telecommunication provider's statement of telecommunications services to the customer.

12. A method for parking, comprising:
a user using a mobile device to identify a parking space;
receiving, via the mobile device, information regarding parking in the parking space;
selecting to pay a fee to park in the parking space; and
charging the fee to a mobile device account associated with the user's mobile device.

13. The method of claim 12, wherein the user uses the mobile device to identify the parking space by:
identifying an identifier located adjacent the parking; and
entering the identifier via the mobile device.

14. The method of claim 12, wherein the user uses the mobile device to identify the parking space by:
a component determining a location of the mobile device; and
a second component identifying the parking space based on the location of the mobile device.

15. The method of claim 14, wherein the second component uses a location of the parking meter and compares the location of the parking meter with the location of the mobile device to identify the parking space.

16. The method of claim 12, further comprising the user using the mobile device to locate a vacant parking space.

17. The method of claim 12, further comprising:
notifying the user, via the mobile device, regarding a parking time expiration; and
the user selecting to pay an additional fee to park in the parking space.

18. The method of claim 12, further comprising
notifying when the user vacates the parking space; and
the user receiving a refund when the user vacates the space before an expiration of time paid for by the fee.

19. The method of claim 12, further comprising:
paying a municipality a payment, at least a portion of the payment related to the fee the user selected to pay to park in the parking space.

20. A device for wireless telecommunications, comprising:
a display;
a processor; and
a graphical user interface having a parking aspect displayable on the display such that responsive to a user of the device selecting the parking aspect, the processor is programmed to:
identify a parking space,
receive information regarding parking in the parking space, and
responsive to the user selecting to pay a fee to park in the parking space, promoting charging the fee to a device account associated with the user's device.

21. The device of claim 20, wherein the graphical user interface displays the fee associated with parking in the parking space.

22. A system for parking enforcement, comprising:
an enforcement device having a display to display a graphical user interface (GUI) that identifies a plurality of parking spaces and indicia associated with each of the plurality of parking spaces, the indicia indicating whether a parking fee has been paid for the associated parking space.

23. The system of claim 22, further comprising:
a printing mechanism to print a ticket for parking violators.

24. The system of claim 23, further comprising:
a telecommunication provider;
a mobile device supported by the telecommunication provider, the mobile device promoting a customer identifying one of the parking space and further promoting the customer selecting to pay for the one of the parking spaces, wherein the telecommunication provider bills the customer for fees associated with the one of the parking spaces in response to the customer selecting to pay for the one of the parking spaces; and
a server to track parking information including the one of the parking spaces paid for by the customer using the mobile device and communicate the parking information to the device.
